(19) United States
(12) Patent Application Publication
(10) Pub. No.: US 2014/0002927 A1
(43) Pub. Date: Jan. 2, 2014

(54) WRITE HEAD STRUCTURE DESIGNED FOR TEMPERATURE INSENSITIVE WRITING PERFORMANCE

(71) Applicants: Wen-Chien D. Hsiao, San Jose, CA (US); Terence T.L. Lam, Cupertino, CA (US); Yansheng Luo, Fremont, CA (US); Xinjiang Shen, Fremont, CA (US)

(72) Inventors: Wen-Chien D. Hsiao, San Jose, CA (US); Terence T.L. Lam, Cupertino, CA (US); Yansheng Luo, Fremont, CA (US); Xinjiang Shen, Fremont, CA (US)

(73) Assignee: Hitachi Global Storage Technologies Netherlands B.V., Amsterdam (NL)

(21) Appl. No.: 13/536,880

(22) Filed: Jun. 28, 2012

(51) Int. Cl. G11B 5/187

(52) U.S. Cl. 360/122; G9B/5.051

(57) ABSTRACT

A magnetic write head for magnetic data recording that includes a structure having a low coefficient of thermal expansion for controlling thermal expansion of the write head. The structure having a low coefficient of thermal expansion has a shape that substantially conforms to the shape of the write coil, such that both the write coil and the structure having a low coefficient of thermal expansion have a central portion that is located closest to the air bearing surface and outer end portions that bend away from the air bearing surface to form a horseshoe shape.

### FIELD OF THE INVENTION

The present invention relates to magnetic data recording and more particularly to a write head having a structure that provides consistent writing performance over a wide range of temperatures.

### BACKGROUND OF THE INVENTION

The heart of a computer is an assembly that is referred to as a magnetic disk drive. The magnetic disk drive includes a rotating magnetic disk, write and read heads that are suspended by a suspension arm adjacent to a surface of the rotating magnetic disk and an actuator that swings the suspension arm to place the read and write heads over selected circular tracks on the rotating disk. The read and write heads are directly located on a slider that has an air bearing surface (ABS). The suspension arm biases the slider into contact with the surface of the disk when the disk is not rotating, but when the disk rotates air is swirled by the rotating disk. When the slider rides on the air bearing, the write and read heads are employed for writing magnetic impressions to and reading magnetic impressions from the rotating disk. The read and write heads are connected to processing circuitry that operates according to a computer program to implement the writing and reading functions.

The write head includes at least one coil, a write pole and one or more return poles. When a current flows through the coil, a resulting magnetic field causes a magnetic flux to flow through the write pole, which results in a magnetic write field emitting from the tip of the write pole. This magnetic field is sufficiently strong that it locally magnetizes a portion of the adjacent magnetic disk, thereby recording a bit of data. The write field, then, travels through a magnetically soft under-layer of the magnetic medium to return to the return pole of the write head.

A magnetoresistive sensor such as a Giant Magnetoresistive (GMR) sensor, or a Tunnel Junction Magnetoresistive (TMR) sensor can be employed to read a magnetic signal from the magnetic media. The sensor includes a nonmagnetic conductive layer (if the sensor is a GMR sensor) or a thin nonmagnetic, electrically insulating barrier layer (if the sensor is a TMR sensor) sandwiched between first and second ferromagnetic layers, hereinafter referred to as a pinned layer and a free layer. Magnetic shields are positioned above and below the sensor stack and can also serve as first and second electrical leads so that the electrical current travels perpendicularly to the plane of the free layer, spacer layer and pinned layer (current perpendicular to the plane (CPP) mode of operation). The magnetization direction of the pinned layer is pinned perpendicular to the air bearing surface (ABS) and the magnetization direction of the free layer is located parallel to the ABS, but free to rotate in response to external magnetic fields. The magnetization of the pinned layer is typically pinned by exchange coupling with an antiferromagnetic layer.

When the magnetizations of the pinned and free layers are parallel with respect to one another, scattering of the conduction electrons is minimized and when the magnetizations of the pinned and free layer are antiparallel, scattering is maximized. In a read mode the resistance of the spin valve sensor changes about linearly with the magnitudes of the magnetic fields from the rotating disk. When a sense current is conducted through the spin valve sensor, resistance changes cause potential changes that are detected and processed as playback signals.

One of the parameters that greatly affects the performance of a magnetic head is the magnetic spacing. In a write head, the spacing between the tip of the magnetic write pole and the magnetic recording layer of the magnetic media defines the magnetic spacing of the write head. The strength of the magnetic write field drops off exponentially with increasing magnetic spacing, so a magnetic spacing that is too large adversely affects the performance of the write head. On the other hand, if the magnetic spacing is too small, the write pole can actually make contact with the magnetic media causing damage to the media and/or write head and resulting in loss of data.

Because structures of the magnetic write head have inherent thermal expansion properties, differences in the temperature environment in which the write head operates can affect the magnetic spacing. In a very hot environment the write head may protrude excessively toward the media, causing head disk contact. In a cold environment, the magnetic write pole of the write head may retract causing weak write field and poor writing performance. Therefore, there remains a need for a structure that can control this temperature affect to allow magnetic data to be recorded reliably over a wide range of operating temperatures.

### SUMMARY OF THE INVENTION

The present invention provides a magnetic write head that includes a magnetic pole structure and a non-magnetic, electrically conductive write coil having a shape that includes a relatively narrow central portion that is disposed near an air bearing surface and end portions that bend away from the air bearing surface. The write head has a structure having a low coefficient of thermal expansion formed adjacent to the magnetic pole structure and having a shape that substantially conforms with the shape of the write coil.

The novel “U” shape or “horseshoe” shape of the low thermal expansion structure (which substantially conforms to the shape of the write coil) advantageously causes the write head to have stable, constant write performance over a wide range of operating temperatures.

These and other features and advantages of the invention will be apparent upon reading of the following detailed description of preferred embodiments taken in conjunction with the Figures in which like reference numerals indicate like elements throughout.

### BRIEF DESCRIPTION OF THE DRAWINGS

For a fuller understanding of the nature and advantages of this invention, as well as the preferred mode of use, reference should be made to the following detailed description read in conjunction with the accompanying drawings which are not to scale.

FIG. 1 is a schematic illustration of a disk drive system in which the invention might be embodied;

FIG. 2 is an ABS view of a slider illustrating the location of a magnetic head thereon;

FIG. 3 is a side cross sectional view of a magnetic head according to an embodiment of the invention;

FIG. 4 is a top down view as seen from line 4-4 of FIG. 3;

FIG. 5 is a graph showing magnetic head performance at different temperatures; and

FIG. 6 is a graph showing head disk spacing for various magnetic head structures.

### DETAILED DESCRIPTION OF THE PREFERRED EMBODIMENTS

The following description is of the best embodiments presently contemplated for carrying out this invention. This description is made for the purpose of illustrating the general principles of this invention and is not meant to limit the inventive concepts claimed herein.

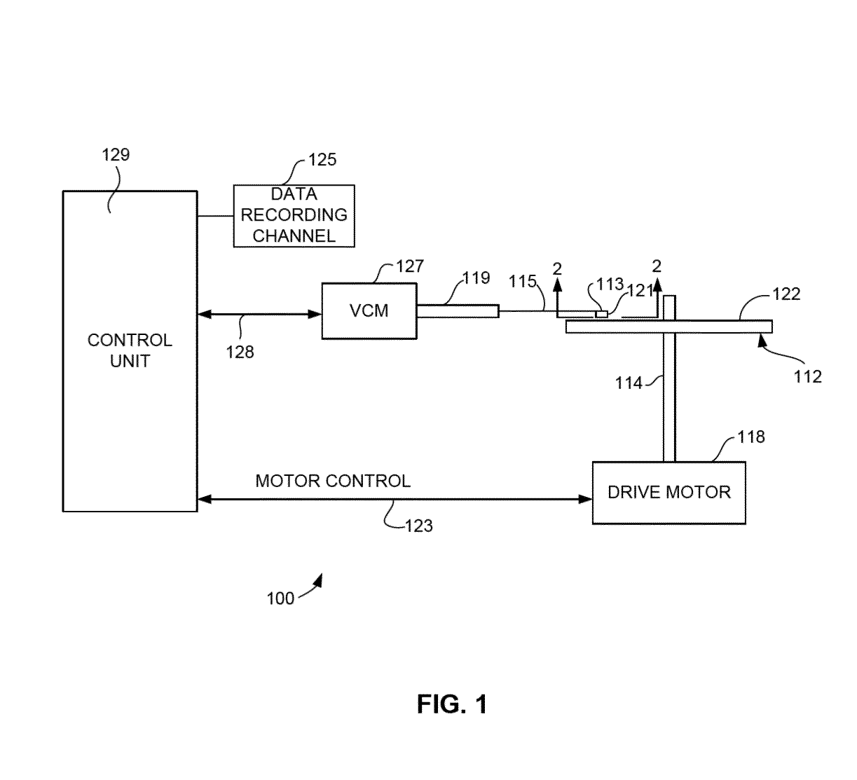

Referring now to FIG. 1, there is shown a disk drive 100 embodying this invention. As shown in FIG. 1, at least one rotatable magnetic disk 112 is supported on a spindle 114 and rotated by a disk drive motor 118. The magnetic recording on each disk is in the form of annular patterns of concentric data tracks (not shown) on the magnetic disk 112.

At least one slider 113 is positioned near the magnetic disk 112, each slider 113 supporting one or more magnetic head assemblies 121. As the magnetic disk rotates, slider 113 moves radially in and out over the disk surface 122 so that the magnetic head assembly 121 can access different tracks of the magnetic disk where desired data are written. Each slider 113 is attached to an actuator arm 119 by way of a suspension 115. The suspension 115 provides a slight spring force which biases slider 113 against the disk surface 122. Each actuator arm 119 is attached to an actuator means 127. The actuator means 127 as shown in FIG. 1 may be a voice coil motor (VCM). The VCM comprises a coil movable within a fixed magnetic field, the direction and speed of the coil movements being controlled by the motor current signals supplied by controller 129.

During operation of the disk storage system, the rotation of the magnetic disk 112 generates an air bearing between the slider 113 and the disk surface 122 which exerts an upward force or lift on the slider. The air bearing thus counter-balances the slight spring force of suspension 115 and supports slider 113 off and slightly above the disk surface by a small, substantially constant spacing during normal operation.

The various components of the disk storage system are controlled in operation by control signals generated by control unit 129, such as access control signals and internal clock signals. Typically, the control unit 129 comprises logic control circuits, storage means and a microprocessor. The control unit 129 generates control signals to control various system operations such as drive motor control signals on line 123 and head position and seek control signals on line 128. The control signals on line 128 provide the desired current profiles to optimally move and position slider 113 to the desired data track on disk 112. Write and read signals are communicated to and from write and read heads 121 by way of recording channel 125.

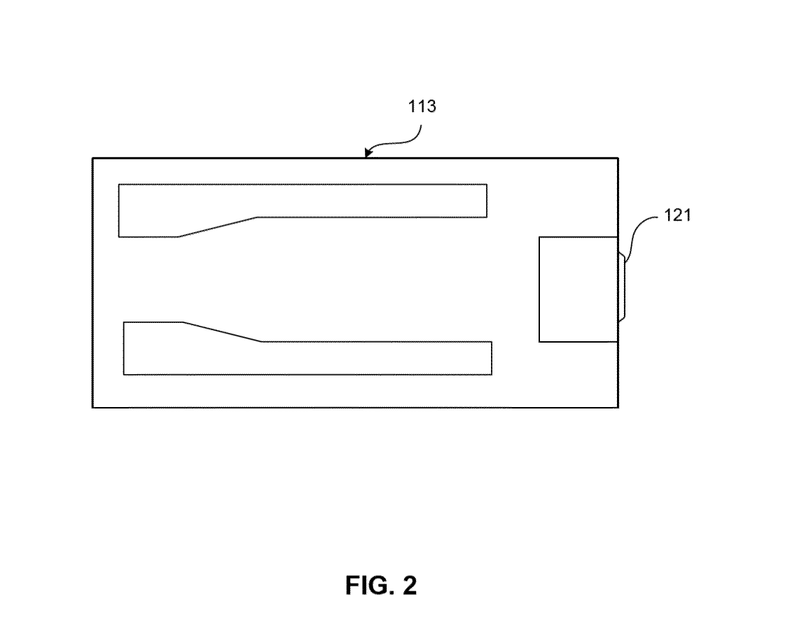

With reference to FIG. 2, the orientation of the magnetic head 121 in a slider 113 can be seen in more detail. FIG. 2 is an ABS view of the slider 113, and as can be seen the magnetic head including an inductive write head and a read sensor, is located at a trailing edge of the slider. The above description of a typical magnetic disk storage system and the accompanying illustration of FIG. 1 are for representation purposes only. It should be apparent that disk storage systems may contain a large number of disks and actuators, and each actuator may support a number of sliders.

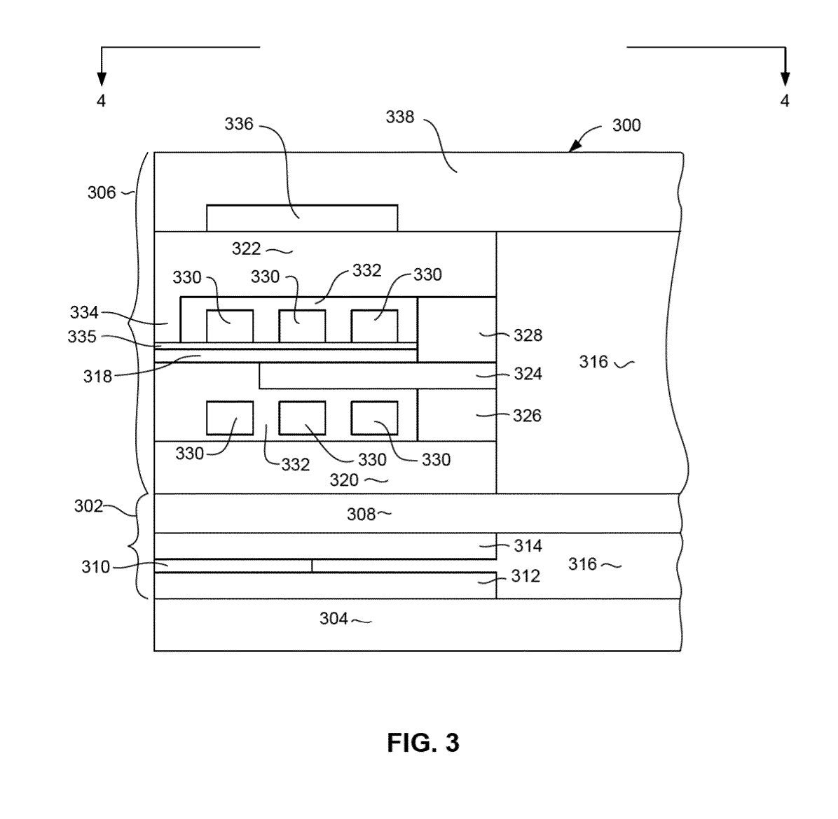

FIG. 3 shows a side, cross sectional view of magnetic head 300 according to a possible embodiment of the invention. The magnetic head 300 includes a read head 302 formed on a slider body substrate 304, and a write head 306 formed over the read head 302. The read head 302 and write head 306 may be separated by a non-magnetic spacer layer 308 such as alumina. The read head 302 can include a magnetoresistive sensor element 310 sandwiched between first and second magnetic shields 312, 314, all of which can be encased in a non-magnetic electrically insulating fill layer 316 such as alumina.

The write head 306 includes a magnetic write pole 318, a leading magnetic return pole 320, and may include a trailing return pole 322. The write pole 318 can be magnetically connected with a magnetic shaping layer 324 that helps to conduct magnetic flux to the write pole. The write pole 318 and shaping layer 324 can be magnetically connected with the return poles 320, 322 by magnetic back gap structures 326, 328. The write head 306 also includes a non-magnetic, electrically conductive write coil 330, which can be constructed of a material such as Cu and which is shown in cross section in FIG. 3. The write coil 330 can be embedded in one or more non-magnetic insulation layers 332 which can be a material such as alumina and/or hard baked photoresist.

When an electrical current flows through the write coil 330, a resulting magnetic field causes a magnetic flux to flow through the magnetic layers 320, 326, 324, 328, 318, 322. This causes a write field being emitted from the tip of the write pole 318 at the ABS, which can write a bit of data to an adjacent magnetic medium (not shown in FIG. 3). A magnetic trailing shield 334 can be provided adjacent to the trailing edge of the write pole 318 and can be connected with the trailing return pole 322 as shown in FIG. 3. The magnetic shield 334 is separated from the trailing edge of the write pole 318 by a non-magnetic trailing gap layer 335. This trailing magnetic shield 334 increases the field gradient of the write field being emitted from the write pole 318. This results in improved magnetic switching during writing of data.

One challenge that occurs when writing data at very high data densities and at very low fly heights, is that of thermal protrusion. The materials making up the read and write heads have thermal expansion coefficients that cause them to expand when exposed to high temperatures. This thermal expansion causes portions of the read and write heads to protrude outward from the ABS, which reduces the magnetic spacing and in extreme cases can cause head disk contact. Such head disk contact can damage the head 300 as well as the magnetic disk and can lead to loss of data or failure of the disk drive system. This problem is worse for the write head 306, because heat generated by the current flow through the write coil increases the thermal expansion of the various structures of the write head 306.

While the amount of heating from the coil can be predicted and accounted for, the environment in which the disk drive system is to be used cannot. The disk drive system may be used in a relatively cold ambient environment, or could be used in a very hot ambient environment. It is desired that the amount of thermal expansion of the elements of the write head be as constant as possible regardless of whether the disk drive is to be used in a hot or cold ambient environment.

To this end, the present invention can be provided with a structure 336 formed adjacent to the write head 306 that is designed to prevent or limit the thermal expansion of the write head. The structure 336 is constructed of a material having a low coefficient of thermal expansion (low CTE) and can be referred to as a low CTE structure 336. The structure 336 preferably has a thermal expansion coefficient of less than 6E-6 C°-1. The low CTE structure is preferably constructed of TiC which provides the desired low coefficient of thermal expansion and which has other properties that are well suited to use preventing thermal expansion of the write head 306. A protective overcoat, such as alumina 338 can be formed over the write head 306 and low CTE structure 336 in order to protect the write head 306 and low CTE structure 336 from wear or corrosion.

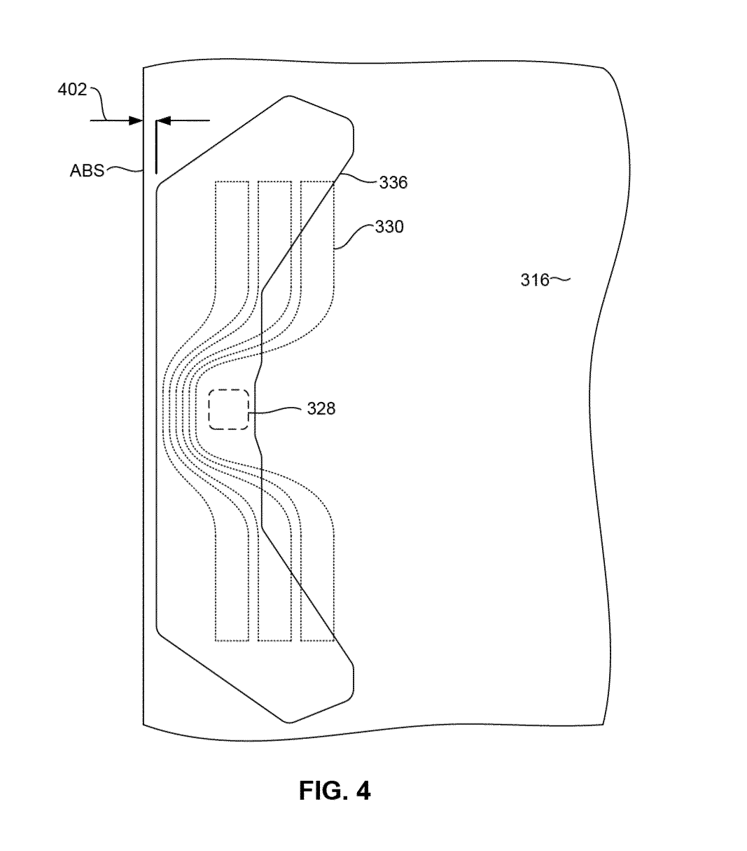

The low CTE structure 336 has a novel configuration that makes it particularly well suited to controlling the thermal expansion of the write head 306, and which makes this control relatively constant over a wide range of temperatures. This can be seen more clearly with reference to FIG. 4 which shows a top down view as seen from line 4-4 of FIG. 3. In FIG. 4, the low TCE structure 336 is shown in solid line and the coil 330 is show in dotted line to indicate that it is beneath the low CTE structure 330. In addition, the back gap 328 is show in dashed line. In FIG. 4 various portion of the write head such as the trailing return pole 322 (FIG. 3) are not shown so that the relationship between the coil 330, low CTE structure 336 and ABS can be seen more clearly.

Because the structure 336 is constructed of a material having a low thermal coefficient of expansion, its size is little affected by temperature variations. If structures of the write head 306 (FIG. 3) are affected by thermal variations causing them to expand, the low TCE structure formed adjacent thereto physically holds the structures of the write head 306 back preventing expansion or contraction.

In FIG. 4 it can be seen that the low CTE structure 336 has a bent shape that can be referred to as a “horseshoe” or “U” shape. It can also be seen that the write coil 330 bends away from the ABS, having a centrally disposed, narrow, closed pack portion between the back gap 328 and the ABS and having outer end portions that bend away from the ABS and become wider after passing into the side regions that are not between the back gap 328 and ABS. In FIG. 4, only one set of coil leads (e.g. upper leads) are shown, however, those skilled in the art will appreciate that the upper leads shown in FIG. 4 can be connected with the lower leads of the coil 330 (as shown in FIG. 3) via electrically conductive stud structures (not shown). This connection between the upper and lower leads is made in the outer end regions of the leads as shown in FIG. 4. Making these outer end portions of the leads wider and more spread out as shown in FIG. 4 facilitates this electrical connection. It can also be seen that the leads bend away from the ABS in these outer regions so that the coil structure 330 forms a bent horseshoe or U shaped structure.

Therefore, it can be seen in FIG. 4, that the low CTE structure 336 generally conforms to the shape of the coil structure 330. While the low CTE structure 336 may not exactly match the shape of the coil 330, it is bent in a similar manner and generally conforms to the shape of the coil 330. Constructing the low TCE structure 336 with such a conformal, bent shape greatly improves the ability of the structure 336 to control thermal protrusion of the write head over a wide range of temperatures. In addition to the bent horseshoe shape of the low CTE structure 366, controlling the spacing between the front edge of the low CTE structure 336 and the ABS also promotes good thermal protrusion control. To this end, the front edge of the low CTE structure is preferably recessed a distance 402 of 1-3 μm or about 3 μm. The conformal horse shoe shape of the low CTE structure helps to control the expansion rate at different temperature and reduce temperature dependence.

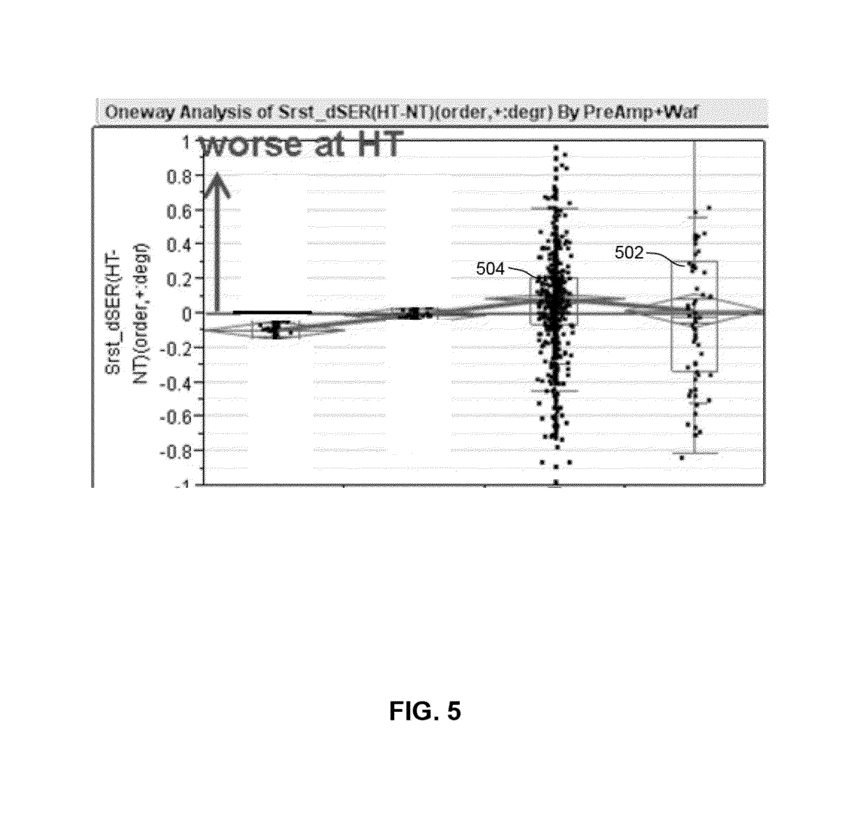

FIG. 5 shows signal error rate for (SER) delta between ambient and high temperature, which is the performance improvement metric. A SER delta of 0 is the design target. The signal error rate for a write head using the current invention is shown in column 502, and has 0 SER delta compared to earlier design which is shown in the third column 504 and which has SER delta of 0.1 order being worse at high temperature.

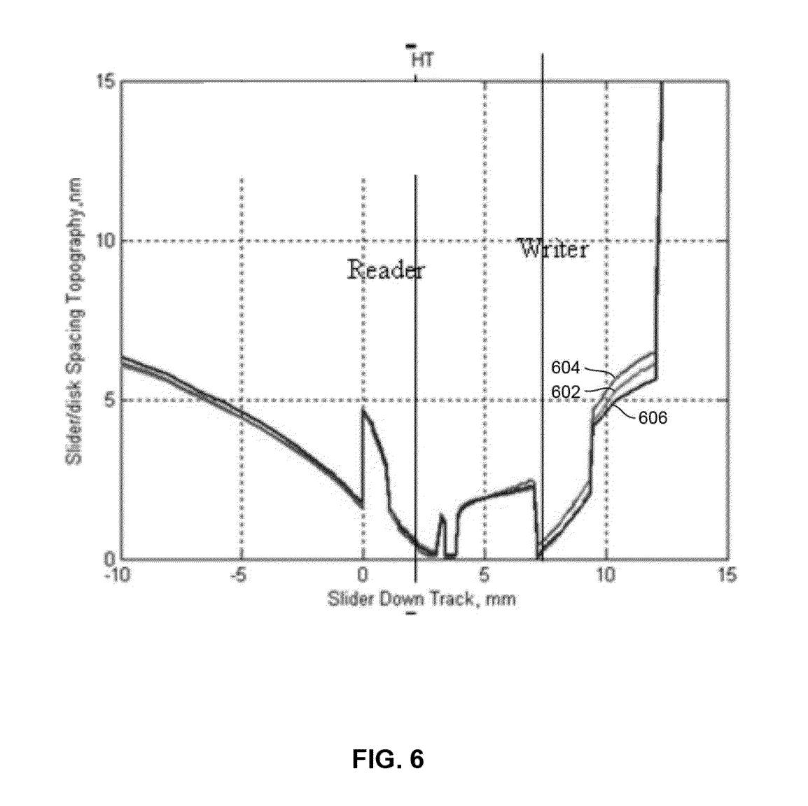

FIG. 6 is a graph showing the head disk spacing for various portions of a read/write head. Line 602 shows spacing for a head having no low TCE structure at all. Line 604 shows the spacing for a head having a low TCE structure that is not conformal as described above. Line 606 shows the head disk spacing for a magnetic head according to the invention such as described above, wherein the head has a low TCE structure that conforms to the write coil as shown in FIG. 4. As can be seen, in FIG. 6 the head having the conformal low TCE structure has a head disk spacing that is least affected by temperature variation. The constant write spacing from ambient to high temperature greatly improves writer performance, providing a 0 SER delta over a wide temperature range.

While various embodiments have been described above, it should be understood that they have been presented by way of example only and not limitation. Other embodiments falling within the scope of the invention may also become apparent to those skilled in the art. Thus, the breadth and scope of the invention should not be limited by any of the above-described exemplary embodiments, but should be defined only in accordance with the following claims and their equivalents.

1. A magnetic write head, comprising:
a magnetic pole structure;
a non-magnetic, electrically conductive write coil, the coil having a shape that includes a relatively narrow central portion that is disposed near an air bearing surface and end portions that bend away from the air bearing surface; and
a structure having a low coefficient of thermal expansion formed adjacent to the magnetic pole structure and having a shape that substantially conforms with the shape of the write coil.

2. The write head as in claim I wherein the structure having a low coefficient of thermal expansion has a coefficient of thermal expansion of less than 6E-6 C°-1.

3. The write head as in claim 1 wherein the structure having a low coefficient of thermal expansion comprises TiC.

4. The write head as in claim 1 wherein the structure having a low coefficient of thermal expansion has a bent shape having a central portion that is closest to the air bearing surface and end portions that bend away from the air bearing surface.

5. The write head as in claim 1 wherein the structure having a low coefficient of thermal expansion has a front edge closest to the air bearing surface that is recessed from the air bearing surface by a distance of 1-3 μm.

6. The write head as in claim 1 wherein the structure having a low coefficient of thermal expansion has a thickness measured parallel with the air bearing surface of 1-3 μm.

7. The write head as in claim I wherein at least a portion of the write coil is located adjacent to a first side of the magnetic pole structure and the structure having a low coefficient of thermal expansion is located adjacent to a second side of the magnetic pole opposite the first side.

8. The write head as in claim 1 wherein the magnetic pole structure is a magnetic return pole, the magnetic write head further comprising a magnetic write pole, and wherein a portion of the non-magnetic, electrically conductive write coil passes between the magnetic write pole and the magnetic return pole.

9. A magnetic write head, comprising:
a structure comprising a material having a low coefficient of thermal expansion, the structure having a central portion that is located near an air bearing surface and end portions that bend away from the air bearing surface.

10. The magnetic write head as in claim 9 wherein the structure has a horseshoe shape.

11. The magnetic write head as in claim 9 wherein the structure comprises a material having a coefficient of thermal expansion of less than 6E-6 C°-1.

12. The magnetic write head as in claim 9 wherein the structure comprises TiC.

13. The magnetic write head as in claim 9 wherein the central portion of the structure has a front edge that is recessed from the air bearing surface by a distance of 1-3 μm.

14. The magnetic write head as in claim 9 wherein the structure has a thickness measured parallel with the ABS of 1-3 μm.

15. A magnetic write head, comprising:
a magnetic write pole extending to an air bearing surface;
a magnetic return pole that is magnetically connected with the write pole in a region removed from the air bearing surface;
a non-magnetic, electrically conductive write coil having a central portion that passes between the magnetic write pole and the magnetic return pole and having end portions that bend away from the air hearing surface; and
a structure having a low coefficient of thermal expansion located adjacent to the magnetic return pole and having a shape the substantially conforms with the write coil.

16. The magnetic write head as in claim 15 wherein the structure having a low coefficient of thermal expansion has a central portion that is located closest to the air bearing surface and end portions that bend away from the air bearing surface.

17. The magnetic write head as in claim 15 wherein the structure having a low coefficient of thermal expansion comprises a material having a coefficient of thermal expansion of less than 6E-6 C°-1.

18. The magnetic write head as in claim 15 wherein the structure having a low coefficient of thermal expansion comprises TiC.

19. The magnetic write head as in claim 15 wherein the structure having a low coefficient of thermal expansion has a thickness of 1-3 μm.

20. The magnetic write head as in claim 15 wherein the structure having a low coefficient of thermal expansion has a front edge that is recessed from the air bearing surface by a distance of 1-3 μm.
